(19) United States
(12) Patent Application Publication
(10) Pub. No.: US 2023/0112892 A1
(43) Pub. Date: Apr. 13, 2023

(54) CHIP PATCH ANTENNA AND CHIP PATCH ANTENNA MODULE

(71) Applicant: Samsung Electro-Mechanics Co., Ltd., Suwon-si (KR)

(72) Inventors: Youngjo CHOI, Suwon-si (KR); Chin Mo KIM, Suwon-si (KR); Jae Yeong KIM, Suwon-si (KR); Eun Ju OH, Suwon-si (KR)

(73) Assignee: Samsung Electro-Mechanics Co., Ltd., Suwon-si (KR)

(21) Appl. No.: 17/861,683

(22) Filed: Jul. 11, 2022

(30) Foreign Application Priority Data
Oct. 13, 2021 (KR) 10-2021-0135792

(51) Int. Cl. H01Q 9/04; H01Q 1/42; H01Q 21/06; H01Q 21/00; H01Q 1/22

(52) U.S. Cl. CPC H01Q 9/0414; H01Q 1/422; H01Q 21/065; H01Q 21/0006; H01Q 1/2283

(57) ABSTRACT

A chip patch antenna includes an upper dielectric layer including a first dielectric material and a second dielectric material having different dielectric constants from each other and bonded to each other in a planar direction, a first patch antenna electrode and a second patch antenna electrode respectively disposed on one side of each of the first dielectric material and the second dielectric material, a lower dielectric layer spaced from the first dielectric material and the second dielectric material in a thickness direction, and a third patch antenna electrode and a fourth patch antenna electrode disposed on one side of the lower dielectric layer.

### CROSS-REFERENCE TO RELATED APPLICATIONS

This application claims the benefit under 35 USC 119(a) of Korean Patent Application No. 10-2021-0135792 filed in the Korean Intellectual Property Office on Oct. 13, 2021, the entire contents of which are incorporated herein by reference for all purposes.

### BACKGROUND

### 1. Field

The present disclosure relates to a chip patch antenna and a chip patch antenna module.

### 2. Description of the Background

The current mobile communication traffic in the world is predicted to increase an annual average of 53%, and the core industry of the fourth industrial revolution, such as the Internet of things (IoT), autonomous vehicles, virtual reality (VR), robots, and big data need a huge volume of data, so the 5G communication is necessary.

In the earlier stage of the 5G service, a specific hot spot based service is expected to be gradually developed into a wide area service securing mobility without limits of places and areas, and particularly, regarding the wide area service securing mobility, a base station increases the using number of macro cells and small cells, and a terminal requires high-power transmission and receiving for allowing middle and long distance transmission and receiving, so a large number of array antennae will be used. However, the terminal down-sizing issue will continue, so it is needed to reduce the size and increase the antenna efficiency.

When a printed circuit board radio frequency (PCB RF) module is configured, configurations for maximizing transmission and receiving by realizing horizontal polarization and vertical polarization by using a patch antenna using a substrate are widely used, but they have limits in sizes and positional degrees of freedom because of restrictions of dielectric constants of dielectric material substrates. When an antenna is manufactured by use of a ceramic material, it is not easy to cover a plurality of bands with a single chip antenna to use multiple bands, and two chip antennas are configured by distinguishing a high band and a low band, so a mounting area increases in a horizontal direction.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a chip patch antenna includes an upper dielectric layer including a first dielectric material and a second dielectric material having different dielectric constants from each other and bonded to each other in a planar direction, a first patch antenna electrode and a second patch antenna electrode respectively disposed on one side of each of the first dielectric material and the second dielectric material, a lower dielectric layer spaced from the first dielectric material and the second dielectric material in a thickness direction, and a third patch antenna electrode and a fourth patch antenna electrode disposed on one side of the lower dielectric layer.

A bonding layer may be disposed between the upper dielectric layer and the lower dielectric layer.

A dielectric constant of the bonding layer may be less than dielectric constants of the upper dielectric layer and the lower dielectric layer.

The bonding layer may include through-holes in a portion in which the first dielectric material faces the third patch antenna electrode and a portion in which the second dielectric material faces the fourth patch antenna electrode.

The bonding layer may include polymer or ceramic.

The upper dielectric layer and the lower dielectric layer may maintain a gap with a spacer disposed on an edge, and an air gap may be formed between the third patch antenna electrode and the first dielectric material and between the fourth patch antenna electrode and the second dielectric material.

The spacer may include a plurality of metal spacers, and the metal spacers may be disposed on edges of the upper dielectric layer and the lower dielectric layer.

The lower dielectric layer may include a third dielectric material and a fourth dielectric material having different dielectric constants from each other and bonded to each other in the planar direction.

The third patch antenna electrode may be disposed on one side of the third dielectric material, and the fourth patch antenna electrode may be disposed on one side of the fourth dielectric material.

The lower dielectric layer may have a different dielectric constant from at least one of the first dielectric material and the second dielectric material.

A thickness of the upper dielectric layer may be less than a thickness of the lower dielectric layer.

The chip patch antenna may further include a fifth patch antenna electrode and a sixth patch antenna electrode respectively disposed on an other one side of each of the first dielectric material and the second dielectric material.

The first patch antenna electrode and the third patch antenna electrode may have different sizes from each other, and the second patch antenna electrode and the fourth patch antenna electrode may have different sizes from each other.

The first patch antenna electrode and the second patch antenna electrode may have different sizes from each other, and the third patch antenna electrode and the fourth patch antenna electrode may have different sizes from each other.

The third patch antenna electrode and fourth patch antenna electrode may be configured to be fed through a feed via penetrating the third dielectric material and the fourth dielectric material in the thickness direction.

In another general aspect, a chip patch antenna module includes a substrate, and a chip patch antenna mounted on the substrate, wherein the chip patch antenna includes an upper dielectric layer including a first dielectric material and a second dielectric material having different dielectric constants from each other and bonded to each other in a planar direction, a first patch antenna electrode and a second patch antenna electrode respectively disposed on one side of each of the first dielectric material and the second dielectric material, a lower dielectric layer spaced from the first dielectric material and the second dielectric material in a thickness direction, and a third patch antenna electrode and a fourth patch antenna electrode disposed on one side of the lower dielectric layer.

The dielectric constant of one or more of the upper dielectric layer and the lower dielectric layer may be greater than the dielectric constant of the substrate.

The chip patch antenna may include a first chip patch antenna and a second chip patch antenna neighboring each other, and a metal pattern extending along an edge may be included on respective upper sides of the first chip patch antenna and the second chip patch antenna.

Other features and aspects will be apparent from the following detailed description, the drawings, and the claims.

### BRIEF DESCRIPTION OF THE DRAWINGS

FIG. 1 shows a perspective view of a chip patch antenna according to an embodiment.

FIG. 2 shows a cross-sectional view with respect to a line II-II of FIG. 1.

FIG. 3 shows a bottom view of a base side of a chip patch antenna shown in FIG. 1.

FIG. 4 shows a bottom view of a base side of a chip patch antenna according to another embodiment.

FIG. 5 shows a bottom view of a base side of a chip patch antenna according to still another embodiment.

FIG. 6 shows a cross-sectional view of a chip patch antenna according to another embodiment.

FIG. 7 shows a perspective view of a chip patch antenna according to still another embodiment.

FIG. 8 shows a cross-sectional view with respect to a line VIII-VIII of FIG. 7.

FIG. 9 shows a perspective view of a chip patch antenna according to still another embodiment.

FIG. 10 shows a cross-sectional view with respect to a line X-X of FIG. 9.

FIG. 11 shows an exploded perspective view of a chip patch antenna according to still another embodiment.

FIG. 12 shows an exploded perspective view of a chip patch antenna according to still another embodiment.

FIG. 13 shows a perspective view of a chip patch antenna module according to still another embodiment.

FIG. 14 shows a perspective view of a chip patch antenna module according to still another embodiment.

FIG. 15 shows a top plan view of a chip patch antenna module according to still another embodiment.

FIG. 16 shows a top plan view of a chip patch antenna module according to a comparative example.

FIG. 17 shows a cross-sectional view of a chip patch antenna according to still another embodiment.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

Hereinafter, example embodiments in the present disclosure are described in detail with reference to the accompanying illustrative drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly. A planar direction of a constituent element may include a direction that is parallel to a relatively larger side of the constituent element, and a thickness direction may include a direction that is perpendicular to the relatively larger side of the constituent element. For example, an area of a constituent element, such as a layer, dielectric material, or electrode, refers to a planar area of the constituent element, such as the layer, dielectric material, or electrode.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

The present disclosure provides a chip patch antenna for configuring a high band and a low band into an integrated single chip by configuring a patch antenna into a chip type or a structure using a dielectric material, and a chip patch antenna module for mounting the chip patch antenna on a module substrate.

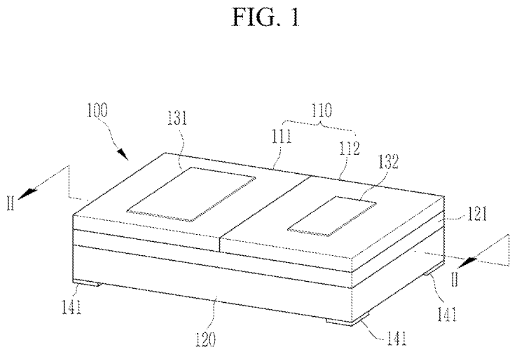

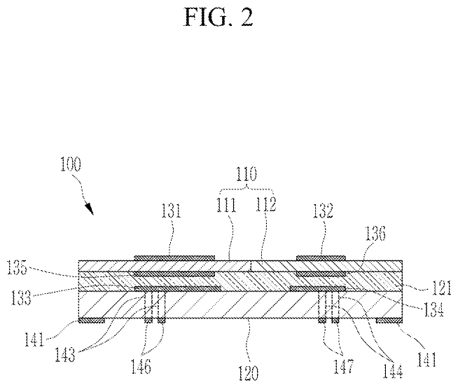

FIG. 1 shows a perspective view of a chip patch antenna according to an embodiment, and FIG. 2 shows a cross-sectional view with respect to a line II-II of FIG. 1.

Referring to FIG. 1 and FIG. 2, the chip patch antenna 100 according to the present embodiment includes an upper dielectric layer 110 and a lower dielectric layer 120 spaced from the upper dielectric layer 110 in a thickness direction, a first patch antenna electrode 131 and a second patch antenna electrode 132 are disposed on the upper dielectric layer 110, and a third patch antenna electrode 133 and a fourth patch antenna electrode 134 are disposed on the lower dielectric layer 120.

The upper dielectric layer 110 includes a first dielectric material 111 and a second dielectric material 112, and the first dielectric material 111 and the second dielectric material 112 are bonded to each other in a planar direction and are integrally formed. Therefore, the first dielectric material 111 and the second dielectric material 112 may be integrally formed on a same plane.

The first dielectric material 111 and the second dielectric material 112 may have different dielectric constants, and for example, the dielectric constant of the second dielectric material 112 may be greater than the dielectric constant of the first dielectric material 111. The first dielectric material 111 and the second dielectric material 112 may have different areas, and for example, the area of the second dielectric material 112 may be less than the area of the first dielectric material 111.

The lower dielectric layer 120 is spaced from the first dielectric material 111 and the second dielectric material 112 in a thickness direction.

A bonding layer 121 may be provided between the upper dielectric layer 110 and the lower dielectric layer 120. The bonding layer 121 may be made of a polymer layer including a polymer, and the dielectric constant of the bonding layer 121 is less than the dielectric constants of the upper dielectric layer 110 and the lower dielectric layer 120. For another example, the bonding layer 121 may be made of a ceramic layer including ceramic. For example, the dielectric constant of the bonding layer 121 may be 1.

The upper dielectric layer 110 and the lower dielectric layer 120 may have different dielectric constants, and for example, the dielectric constant of the upper dielectric layer 110 may be greater than the dielectric constant of the lower dielectric layer 120. That is, the dielectric constants of the first dielectric material 111 and the second dielectric material 112 configuring the upper dielectric layer 110 may be greater than a dielectric constant of a third dielectric material configuring the lower dielectric layer 120.

A thickness of the upper dielectric layer 110 may be less than a thickness of the lower dielectric layer 120. That is, the thicknesses of the first dielectric material 111 and the second dielectric material 112 configuring the upper dielectric layer 110 may be less than the thickness of the lower dielectric layer 120.

The first patch antenna electrode 131 and the second patch antenna electrode 132 may be respectively disposed on one side of the first dielectric material 111 and the second dielectric material 112. The first patch antenna electrode 131 and the second patch antenna electrode 132 may be disposed on one side facing an outside. The first patch antenna electrode 131 and the second patch antenna electrode 132 may have different sizes. For example, the second patch antenna electrode 132 may be smaller than the first patch antenna electrode 131.

The third patch antenna electrode 133 and the fourth patch antenna electrode 134 may be disposed on one side of the lower dielectric layer 120 facing the first dielectric material 111 and the second dielectric material 112.

A fifth patch antenna electrode 135 and a sixth patch antenna electrode 136 may be respectively disposed on the other one side of each of the first dielectric material 111 and the second dielectric material 112. Therefore, the third patch antenna electrode 133 and the fifth patch antenna electrode 135 may be disposed to face each other, and the fourth patch antenna electrode 134 and the sixth patch antenna electrode 136 may be disposed to face each other. The respective patch antenna electrodes may be made of materials such as a conductive paste, a plating, a thin-film deposition, or a conductive film.

The patch antenna electrodes 131, 132, 135, and 136 disposed on the upper dielectric layer 110 may not be physically connected to a feeding line on the substrate. Hence, the first patch antenna electrode 131 and the fifth patch antenna electrode 135 function as an antenna by an induced electromagnetic wave caused by an electromagnetic wave generated by the third patch antenna electrode 133, and the second patch antenna electrode 132 and the sixth patch antenna electrode 136 function as an antenna by an induced electromagnetic wave caused by an electromagnetic wave generated by the fourth patch antenna electrode 134.

The sizes of the patch antenna electrodes 131, 132, 135, and 136 disposed on the upper dielectric layer 110 may be different from the sizes of the patch antenna electrodes 133 and 134 disposed on the lower dielectric layer 120. For example, the patch antenna electrodes 131, 132, 135, and 136 disposed on the upper dielectric layer 110 may be smaller than the patch antenna electrode 133 and 134 disposed on the lower dielectric layer 120. Regarding lengths of the first patch antenna electrode 131 and the second patch antenna electrode 132 according to disposal directions, the first patch antenna electrode 131 may be shorter than the third patch antenna electrode 133, and the second patch antenna electrode 132 may be shorter than the fourth patch antenna electrode 134. For example, the first patch antenna electrode 131 and the second patch antenna electrode 132 may function as waveguides, and may be designed to be shorter than the third patch antenna electrode 133 and the fourth patch antenna electrode 134 by about 5 to 8%.

The third patch antenna electrode 133 and the fourth patch antenna electrode 134 may be configured to be fed from a bottom side of the lower dielectric layer 120 through feed vias 143 and 144 penetrating the lower dielectric layer 120 in the thickness direction. For example, the feed vias 143 and 144 are made into one pair, and one thereof may be used as a feeding line for generating perpendicular polarization and the other thereof may be used as a feeding line for generating horizontal polarization. The feed vias 143 and 144 may be formed to be conductive in the via hole of the lower dielectric layer 120 by use of a conductive paste or a plating method.

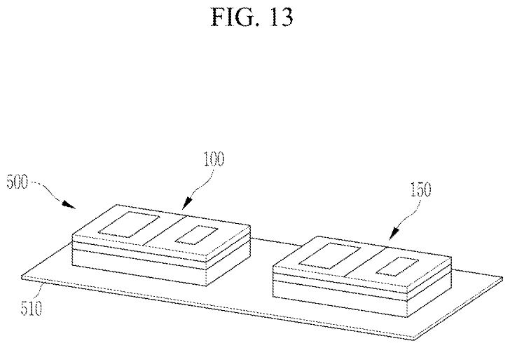

Via electrodes 146 and 147 may be connected to ends of the feed vias 143 and 144. The via electrodes 146 and 147 may be disposed on a lower side of the lower dielectric layer 120 and may be connected to the feed vias 143 and 144, and may be electrically connected to a signal circuit and may transmit antenna signals on the substrate (510; refer to FIG. 13) on which the chip patch antenna 100 is mounted.

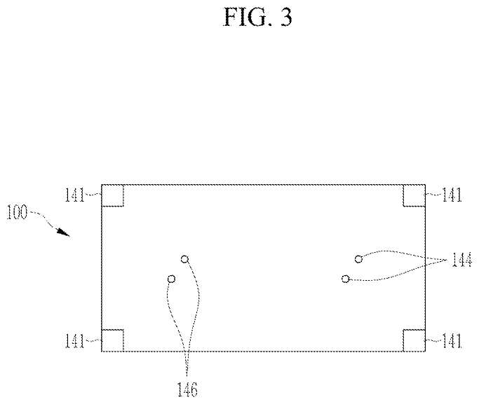

FIG. 3 shows a bottom view of a base side of a chip patch antenna shown in FIG. 1.

Referring to FIG. 3, a lower-side electrode 141 is disposed on the lower side of the lower dielectric layer 120 of the chip patch antenna 100 according to the present embodiment. The lower-side electrode 141 may be disposed at each corner of the lower surface of the lower dielectric layer 120, and it may be connected to a ground line of the substrate (510; refer to FIG. 13) and may allow the chip patch antenna 100 to be mounted on the substrate. The lower-side electrode 141 may be disposed in an island shape at each corner of the lower surface of the lower dielectric layer 120.

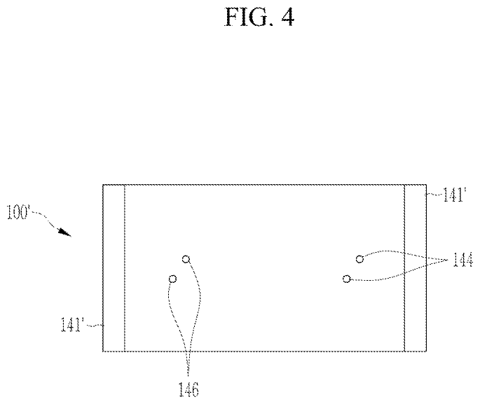

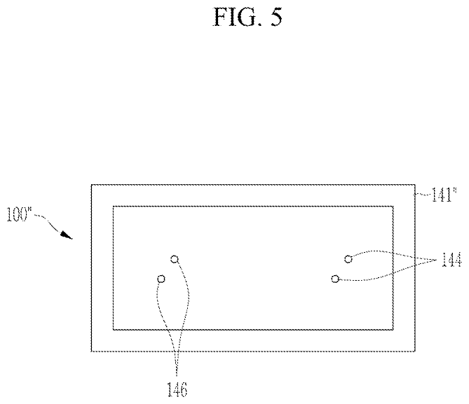

FIG. 4 shows a bottom view of a base side of a chip patch antenna according to another embodiment, and FIG. 5 shows a bottom view of a base side of a chip patch antenna according to still another embodiment.

Referring to FIG. 4, in another embodiment, a lower-side electrode 141′ may be disposed to be a line extending along one pair of edges facing the lower dielectric layer 120. The lower-side electrode 141′ may be connected to the ground line of the substrate (510; refer to FIG. 13) and may allow a chip patch antenna 100′ to be mounted on the substrate.

Referring to FIG. 5, according to still another embodiment, a lower-side electrode 141″ may extend along the edge of the lower dielectric layer 120, may be connected to each other, and may form a quadrangle. The lower-side electrode 141″ may be connected to the ground line of the substrate (510; refer to FIG. 13) and may allow the chip patch antenna 100″ to be mounted on the substrate.

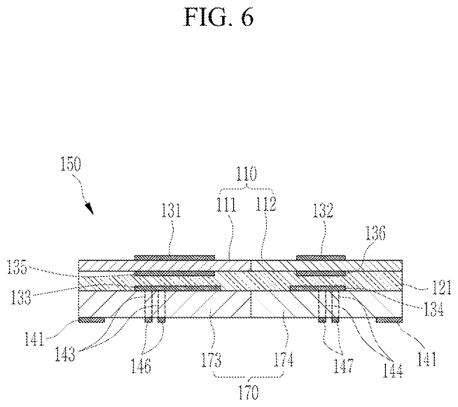

FIG. 6 shows a cross-sectional view of a chip patch antenna according to another embodiment.

Referring to FIG. 6, regarding the chip patch antenna 150 according to the present embodiment, the lower dielectric layer 170 includes a third dielectric material 173 and a fourth dielectric material 174 having different dielectric constants from each other. For example, the dielectric constant of the fourth dielectric material 174 may be greater than the dielectric constant of the third dielectric material 173. The third dielectric material 173 and the fourth dielectric material 174 may have different areas, and for example, the area of the fourth dielectric material 174 may be less than the area of the third dielectric material 173.

Other configurations are equivalent to the chip patch antenna 100 according to an embodiment described with reference to FIG. 1 to FIG. 4. Therefore, regarding the chip patch antenna 150 according to the present embodiment, the upper dielectric layer 110 may include a first dielectric material 111 and a second dielectric material 112 having different dielectric constants with each other, and the upper dielectric layer 110 and the lower dielectric layer 120 may be bonded to each other with the bonding layer 121 therebetween.

For example, the first dielectric material 111 and the third dielectric material 173 may have a same area, and the second dielectric material 112 and the fourth dielectric material 174 may have a same area.

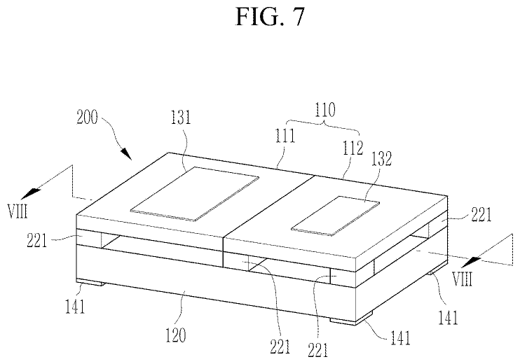

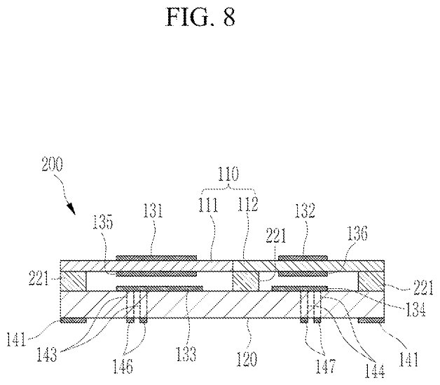

FIG. 7 shows a perspective view of a chip patch antenna according to still another embodiment, and FIG. 8 shows a cross-sectional view with respect to a line VIII-VIII of FIG. 7.

Referring to FIG. 7 and FIG. 8, regarding the chip patch antenna 200 according to the present embodiment, the upper dielectric layer 110 and the lower dielectric layer 120 may maintain a gap with a spacer 221 provided therebetween. Other configurations are equivalent to the chip patch antenna 100 according to an embodiment described with reference to FIG. 1 to FIG. 4.

Multiple spacers 221 may be disposed on the corners of the upper dielectric layer 110 and the lower dielectric layer 120, and for example, each of the spacers 221 may be disposed on the corners of the upper dielectric layer 110 and the lower dielectric layer 120. By this, an air gap may be formed between the third patch antenna electrode 133 and the fifth patch antenna electrode 135 and between the fourth patch antenna electrode 134 and the sixth patch antenna electrode 136. The spacer 221 may include a metal spacer.

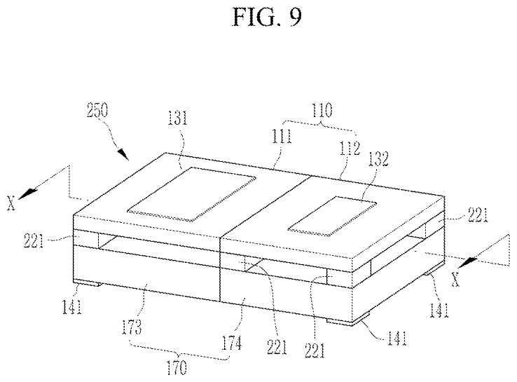

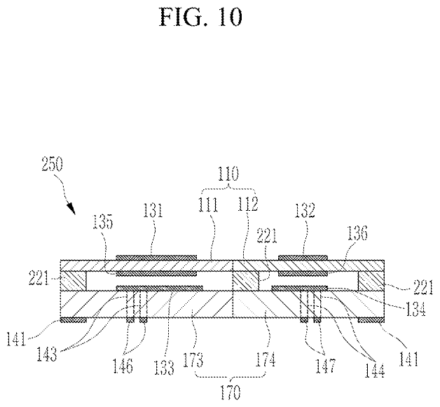

FIG. 9 shows a perspective view of a chip patch antenna according to still another embodiment, and FIG. 10 shows a cross-sectional view with respect to a line X-X of FIG. 9.

Referring to FIG. 9 and FIG. 10, regarding the chip patch antenna 250 according to the present embodiment, the lower dielectric layer 170 includes a third dielectric material 173 and a fourth dielectric material 174 having different dielectric constants. For example, the dielectric constant of the fourth dielectric material 174 may be greater than the dielectric constant of the third dielectric material 173. The third dielectric material 173 and the fourth dielectric material 174 may have different areas, and for example, the area of the fourth dielectric material 174 may be less than the area of the third dielectric material 173.

Other configurations are equivalent to the chip patch antenna 200 according to an embodiment described with reference to FIG. 7 and FIG. 8. Hence, regarding the chip patch antenna 250 according to the present embodiment, the upper dielectric layer 110 includes a first dielectric material 111 and a second dielectric material 112 having different dielectric constants with each other, and the upper dielectric layer 110 and the lower dielectric layer 120 may be bonded to each other with the spacer 221 provided therebetween.

For example, the first dielectric material 111 and the third dielectric material 173 may have the same area, and the second dielectric material 112 and the fourth dielectric material 174 may have the same area.

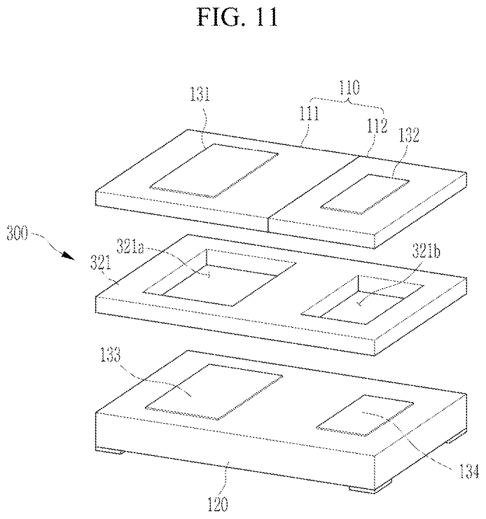

FIG. 11 shows an exploded perspective view of a chip patch antenna according to still another embodiment.

Referring to FIG. 11, regarding the chip patch antenna 300 according to the present embodiment, the upper dielectric layer 110 and the lower dielectric layer 120 may be bonded to each other by a bonding layer 321 provided therebetween, and the bonding layer 321 may include through-holes 321a and 321b. That is, the first through-hole 321a may be formed in a portion in which the first dielectric material 111 faces the third patch antenna electrode 133, and the second through-hole 321b may be formed in a portion in which the second dielectric material 112 faces the fourth patch antenna electrode 134. The first through-hole 321a and the second through-hole 321b may be formed by removing the material of the bonding layer 321 from center areas of the respective dielectric materials 111 and 112, and may be made by the size of the corresponding patch antenna electrode area. Hence, the dielectric constant may become 1 by forming an air gap between the third patch antenna electrode 133 and the fifth patch antenna electrode 135 and between the fourth patch antenna electrode 134 and the sixth patch antenna electrode 136

Other configurations are equivalent to the chip patch antenna 100 according to an embodiment described with reference to FIG. 1 to FIG. 4. Therefore, regarding the chip patch antenna 300 according to the present embodiment, the upper dielectric layer 110 may include a first dielectric material 111 and a second dielectric material 112 having different dielectric constants from each other, and the lower dielectric layer 120 may include a single dielectric material.

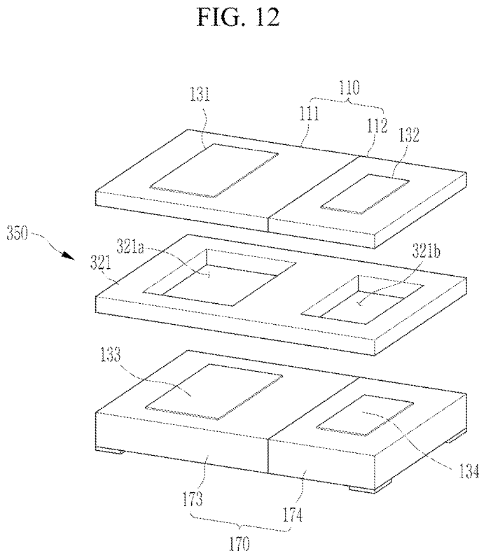

FIG. 12 shows an exploded perspective view of a chip patch antenna according to still another embodiment.

Referring to FIG. 12, regarding the chip patch antenna 350 according to the present embodiment, the lower dielectric layer 170 includes a third dielectric material 173 and a fourth dielectric material 174 having different dielectric constants from each other. Other configurations are equivalent to the chip patch antenna 300 according to an embodiment described with reference to FIG. 11. Therefore, regarding the chip patch antenna 350 according to the present embodiment, the upper dielectric layer 110 may include a first dielectric material 111 and a second dielectric material 112 having different dielectric constants from each other, and the upper dielectric layer 110 and the lower dielectric layer 120 may be bonded to each other with the bonding layer 321 having the through-holes 321a and 321b provided therebetween.

FIG. 13 shows a perspective view of a chip patch antenna module according to still another embodiment.

Referring to FIG. 13, regarding the chip patch antenna module 500 according to the present embodiment, the first chip patch antenna 100 according to an embodiment described with reference to FIG. 1 to FIG. 4 and the second chip patch antenna 150 according to an embodiment described with reference to FIG. 6 may be mounted on the substrate 510.

For example, the respective chip patch antennas 100 and 150 may be mounted on the substrate 510 through the lower-side electrode 141, and may be connected to a signal circuit on the substrate 510 through the via electrode 146 and may be fed for antenna radiation.

The dielectric constants of the dielectric materials of the first chip patch antenna 100 and the second chip patch antenna 150 according to the present embodiment may be greater than the dielectric constant of the material of the substrate 510. By this, when compared to the antenna made of a dielectric material having the same dielectric constant as the substrate, an effect of relatively reducing the size of the antenna may be expected. The effect that the entire size of the antenna module is reduced may be obtained. For example, when the substrate material with the FR4-based dielectric constant of 3 to 4 is used, the chip patch antenna may be made of a polymer material or a ceramic material with the dielectric constant that is greater than that.

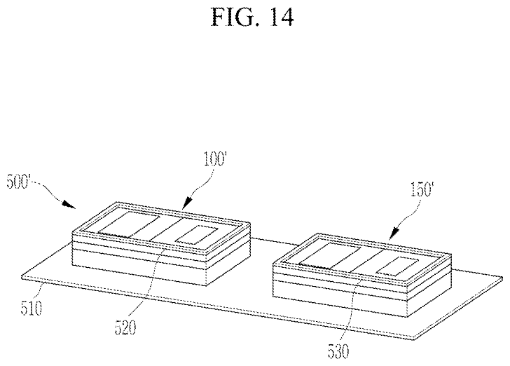

FIG. 14 shows a perspective view of a chip patch antenna module according to still another embodiment.

Referring to FIG. 14, the chip patch antenna module 500′ according to the present embodiment includes a first chip patch antenna 100′ and a second chip patch antenna 150′ mounted on the substrate 510, and the first chip patch antenna 100′ and the second chip patch antenna 150′ respectively include metal patterns 520 and 530 extending along the edge on the upper side. The metal patterns 520 and 530 extend along upper edges of the upper dielectric layers of the first chip patch antenna 100′ and the second chip patch antenna 150′ so they may substantially have a quadrangular shape. The metal patterns 520 and 530 may be useful in reducing interference between respective antennas when the chip patch antennas 100′ and 150′ are disposed in an array structure.

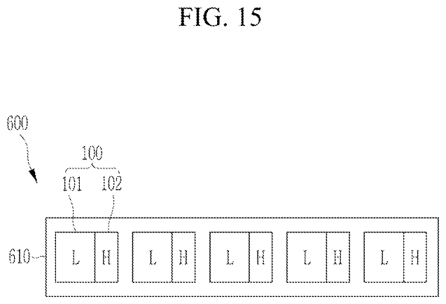

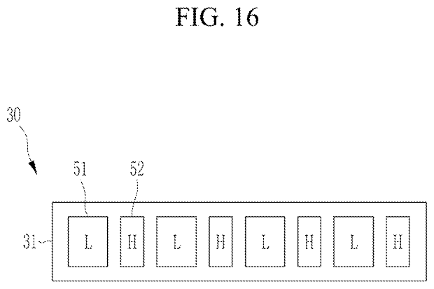

FIG. 15 shows a top plan view of a chip patch antenna module according to still another embodiment, and FIG. 16 shows a top plan view of a chip patch antenna module according to a comparative example.

Referring to FIG. 15, the chip patch antenna module 600 according to the present embodiment may include a plurality of chip patch antennas 100 mounted on the substrate 610, and the respective chip patch antennas 100 may include a low band antenna unit 101 and a high band antenna unit 102. That is, portions configured with the first dielectric material 111 and the second dielectric material 112 having different dielectric constants from each other on the chip patch antenna 100 may respectively configure the low band antenna unit 101 and the high band antenna unit 102. The first dielectric material 111 and the second dielectric material 112 are bonded to each other and are integrally formed, so they have a structure for simultaneously realizing a plurality of bands on the single chip patch antenna 100. Hence, the small antenna that is simple and uses a high dielectric material may be easily realized. The above-described chip patch antennas according to embodiments described with reference to FIG. 1 to FIG. 14 are applicable to the chip patch antenna module 600 described with reference to FIG. 15.

On the other hand, referring to FIG. 16, the chip patch antenna module 30 according to a comparative example is configured with single-band antennas 51 and 52 for the respective chip patch antennas. The low band antenna 51 and the high band antenna 52 are alternately arranged with an interval therebetween on the substrate 31 of the chip patch antenna module 30, so the structure is complicated and there is a limit in down-sizing the antenna.

The chip patch antenna in which two dielectric materials that have different dielectric constants are bonded in a planar direction to form an upper dielectric layer and/or a lower dielectric layer, and the chip patch antenna module on which the chip patch antenna is mounted have been illustrated and described. It is also possible as still another embodiment to bond three or more dielectric materials with different dielectric constants in the planar direction and form the upper dielectric layer and/or the lower dielectric layer, and the chip patch antenna to which the above-noted structure is applied, and the chip patch antenna module belong to the present disclosure. A chip patch antenna including three dielectric materials with different dielectric constants is described below.

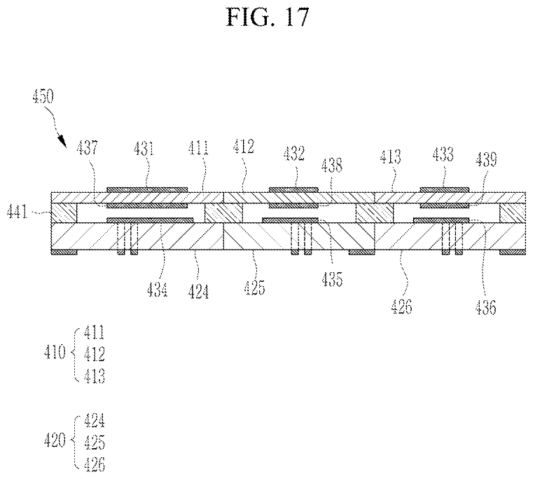

FIG. 17 shows a cross-sectional view of a chip patch antenna according to still another embodiment.

Referring to FIG. 17, the chip patch antenna 450 according to the present embodiment includes an upper dielectric layer 410 and a lower dielectric layer 420 spaced from the upper dielectric layer 410 with a bonding layer 441 therebetween in the thickness direction. A first patch antenna electrode 431, a second patch antenna electrode 432, and a third patch antenna electrode 433 are disposed on one side of the upper dielectric layer 410, and a fourth patch antenna electrode 424, a fifth patch antenna electrode 425, and a sixth patch antenna electrode 426 are disposed on the lower dielectric layer 420. A seventh patch antenna electrode 437, an eighth patch antenna electrode 438, and a ninth patch antenna electrode 439 may be further disposed on another one side of the upper dielectric layer 410.

The upper dielectric layer 410 includes a first dielectric material 411, a second dielectric material 412, and a third dielectric material 413, and the first dielectric material 411, the second dielectric material 412, and the third dielectric material 413 are bonded to each other in the planar direction and are integrally formed. Therefore, the first dielectric material 411, the second dielectric material 412, and the third dielectric material 413 may be integrally formed on the same plane.

The first dielectric material 411, the second dielectric material 412, and the third dielectric material 413 may have different dielectric constants, for example, selected two of them may have the same dielectric constant depending on various combinations. The first dielectric material 411, the second dielectric material 412, and the third dielectric material 413 may have different areas depending on the dielectric constants, and the selected two of them may have the same size of area depending on various combinations.

The lower dielectric layer 420 includes a fourth dielectric material 424, a fifth dielectric material 425, and a sixth dielectric material 426, and they may be spaced from the first dielectric material 411, the second dielectric material 412, and the third dielectric material 413, respectively, in the thickness direction. The fourth dielectric material 424, the fifth dielectric material 425, and the sixth dielectric material 426 may be bonded to each other in the planar direction and may be integrally formed, may have different dielectric constants, and may have different areas. It is also possible for the selected two thereof to have the same dielectric constant depending on various combinations, or for the three dielectric materials to be configured into a single dielectric material having the same dielectric constant. The areas of the respective dielectric materials may be different from each other or may be the same depending on the dielectric constants.

The characteristics described with reference to FIG. 1 to FIG. 15, and FIG. 17 may be selectively combined and applied to other configurations unless they conflict with each other.

According to the chip patch antenna and the chip patch antenna module according to the embodiments, the high band and the low band may be configured into the integrated single chip by configuring the patch antenna in a chip type or a structure using a dielectric material with a different dielectric constant, and the form of the antenna module for mounting the antenna may be freely designed.

Compared to the patch antenna formed as a pattern on the substrate module, the size of the module may be reduced, and a greater number of the antennas may be mounted in the same space, which is advantageous in improving the antenna efficiency.

It is possible to design for compensating deterioration of the gain caused by down-sizing the antenna module by using a simple configuration.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A chip patch antenna comprising:
an upper dielectric layer including a first dielectric material and a second dielectric material having different dielectric constants from each other and bonded to each other in a planar direction;
a first patch antenna electrode and a second patch antenna electrode respectively disposed on one side of each of the first dielectric material and the second dielectric material;
a lower dielectric layer spaced from the first dielectric material and the second dielectric material in a thickness direction; and
a third patch antenna electrode and a fourth patch antenna electrode disposed on one side of the lower dielectric layer.

2. The chip patch antenna of claim 1, wherein a bonding layer is disposed between the upper dielectric layer and the lower dielectric layer.

3. The chip patch antenna of claim 2, wherein a dielectric constant of the bonding layer is less than dielectric constants of the upper dielectric layer and the lower dielectric layer.

4. The chip patch antenna of claim 2, wherein the bonding layer comprises through-holes in a portion in which the first dielectric material faces the third patch antenna electrode and a portion in which the second dielectric material faces the fourth patch antenna electrode.

5. The chip patch antenna of claim 2, wherein the bonding layer comprises polymer or ceramic.

6. The chip patch antenna of claim 1, wherein
the upper dielectric layer and the lower dielectric layer maintain a gap with a spacer disposed on an edge, and
an air gap is formed between the third patch antenna electrode and the first dielectric material and between the fourth patch antenna electrode and the second dielectric material.

7. The chip patch antenna of claim 6, wherein
the spacer includes a plurality of metal spacers, and
the metal spacers are disposed on edges of the upper dielectric layer and the lower dielectric layer.

8. The chip patch antenna of claim 1, wherein the lower dielectric layer includes a third dielectric material and a fourth dielectric material having different dielectric constants from each other and bonded to each other in the planar direction.

9. The chip patch antenna of claim 8, wherein
the third patch antenna electrode is disposed on one side of the third dielectric material, and
the fourth patch antenna electrode is disposed on one side of the fourth dielectric material.

10. The chip patch antenna of claim 8, wherein the third patch antenna electrode and fourth patch antenna electrode are configured to be fed through a feed via penetrating the third dielectric material and the fourth dielectric material in the thickness direction.

11. The chip patch antenna of claim 1, wherein the lower dielectric layer has a different dielectric constant from at least one of the first dielectric material and the second dielectric material.

12. The chip patch antenna of claim 1, wherein a thickness of the upper dielectric layer is less than a thickness of the lower dielectric layer.

13. The chip patch antenna of claim 1, further comprising a fifth patch antenna electrode and a sixth patch antenna electrode respectively disposed on an other one side of each of the first dielectric material and the second dielectric material.

14. The chip patch antenna of claim 1, wherein the first patch antenna electrode and the third patch antenna electrode have different sizes from each other, and the second patch antenna electrode and the fourth patch antenna electrode have different sizes from each other.

15. The chip patch antenna of claim 1, wherein the first patch antenna electrode and the second patch antenna electrode have different sizes from each other, and the third patch antenna electrode and the fourth patch antenna electrode have different sizes from each other.

16. A chip patch antenna module comprising:
a substrate; and
a chip patch antenna mounted on the substrate,
wherein the chip patch antenna comprises:
an upper dielectric layer including a first dielectric material and a second dielectric material having different dielectric constants from each other and bonded to each other in a planar direction,
a first patch antenna electrode and a second patch antenna electrode respectively disposed on one side of each of the first dielectric material and the second dielectric material,
a lower dielectric layer spaced from the first dielectric material and the second dielectric material in a thickness direction, and
a third patch antenna electrode and a fourth patch antenna electrode disposed on one side of the lower dielectric layer.

17. The chip patch antenna module of claim 16, wherein the lower dielectric layer includes a third dielectric material and a fourth dielectric material having different dielectric constants from each other and bonded to each other in the planar direction.

18. The chip patch antenna module of claim 17, wherein
the third patch antenna electrode is disposed on one side of the third dielectric material, and
the fourth patch antenna electrode is disposed on one side of the fourth dielectric material.

19. The chip patch antenna module of claim 16, wherein the dielectric constant of one or more of the upper dielectric layer and the lower dielectric layer is greater than the dielectric constant of the substrate.

20. The chip patch antenna module of claim 16, wherein
the chip patch antenna includes a first chip patch antenna and a second chip patch antenna neighboring each other, and
a metal pattern extending along an edge is included on respective upper sides of the first chip patch antenna and the second chip patch antenna.
